(19) United States
(12) Patent Application Publication
(10) Pub. No.: US 2005/0056373 A1
(43) Pub. Date: Mar. 17, 2005

(54) Reciprocating type protective cover sheet adhering machine

(76) Inventor: Chiu-Fong Huang, Taipei Hsien (TW)

Correspondence Address: BIRCH STEWART KOLASCH & BIRCH, PO BOX 747, FALLS CHURCH, VA, 22040-0747, US

(21) Appl. No.: 10/664,160

(22) Filed: Sep. 17, 2003

(51) Int. Cl. B32B 31/00

(52) U.S. Cl. 156/459; 156/526; 156/577

(57) ABSTRACT

A reciprocating type protective cover sheet adhering machine is constructed to include a machine base, a material feeder adapted to place plate members on the table of the machine base in a stack, and a cover sheet applicator unit, the cover sheet applicator unit including an applicator body to be reciprocated along a track above the machine base below to apply a protective cover sheet to the top and bottom sides of each plate member being carried by the material feeder to the table of the machine base.

### BACKGROUND OF THE INVENTION

1. Field of the Invention

The present invention relates to an adhering machine used to stack plate members in a stack and to pack each plate member with a protective cover sheet during stacking and, more particularly, to a reciprocating type protective cover sheet adhering machine, which saves much labor and processing cost.

2. Description of the Related Art

In our daily life, different planar materials are used to make planar consumers' goods, electric home appliances, or electronic devices, for example, mirrors, planar glasses, acrylics, stainless steel plates, display panels. These planar products must be well packed before delivery, so that they can be maintained intact after delivery to the consumers. Well cut protective cover sheets are commonly used to pack planar products. After a planar product covered with a protective cover sheet, the exposed distal sides of the planar product must be further packed, preventing edge damage during delivery. When a number of planar products well packed, the packed planar products may have to be arranged in a stack for delivery. According to conventional methods, it requires much labor and time to pack planar products individually and then to stack packed planar products in a stack for delivery.

### SUMMARY OF THE INVENTION

The present invention has been accomplished under the circumstances in view. It is the main object of the present invention to provide a reciprocating type protective cover sheet adhering machine, which automatically stacks planar members in a stack and packs each planar member with a protective cover sheet when stacking.

According to one aspect of the present invention, the reciprocating type protective cover sheet adhering machine comprises a machine base having an elevation-adjustable table, a material feeder adapted to place plate members on the table of the machine base in a stack, and a cover sheet applicator unit, the cover sheet applicator unit comprising a track suspended above the table of the machine base below the material feeder, an applicator body adapted to be reciprocated along the track, a let-off wheel installed at the applicator body at a top side, a sheet-transfer wheel set installed at the applicator body at a bottom side, and a roll of protective cover sheet mounted on the let-off wheel for adhering to top and bottom sides of each plate member being carried by the material feeder to the table of the machine base. According to another aspect of the present invention, the applicator body is to be reciprocated along the track over the table of the machine, base to adhere the protective cover sheet to top and bottom sides of each plate member being placed on the table of the machine base by the material feeder at a reciprocating distance greater than the length of the plate members to be packed such that a part of the protective cover sheet protrudes over two distal sides of each protective plate member after packing.

### BRIEF DESCRIPTION OF THE DRAWINGS

FIG. 1 is an elevational view of a reciprocating type protective cover sheet adhering machine according to the present invention.

FIG. 2 is a schematic side view of the reciprocating type protective cover sheet adhering machine before operation.

FIG. 3 is a schematic side view showing the operation of the reciprocating type protective cover sheet adhering machine according to the present invention (I).

FIG. 4 is a schematic side view showing the operation of the reciprocating type protective cover sheet adhering machine according to the present invention (II).

FIG. 5 is a schematic side view of the reciprocating type protective cover sheet adhering machine after operation.

FIG. 6 is a schematic drawing showing a continuous plate member packing operation of the reciprocating type protective cover sheet adhering machine according to the present invention.

FIG. 7 is a schematic side view of an alternate form of the reciprocating type protective cover sheet adhering machine according to the present invention.

### DETAILED DESCRIPTION OF THE PREFERRED EMBODIMENT

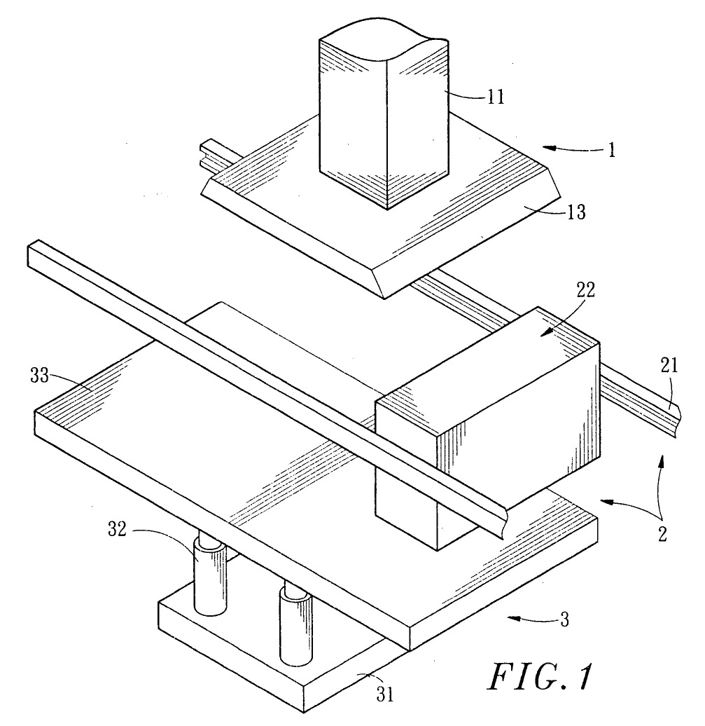

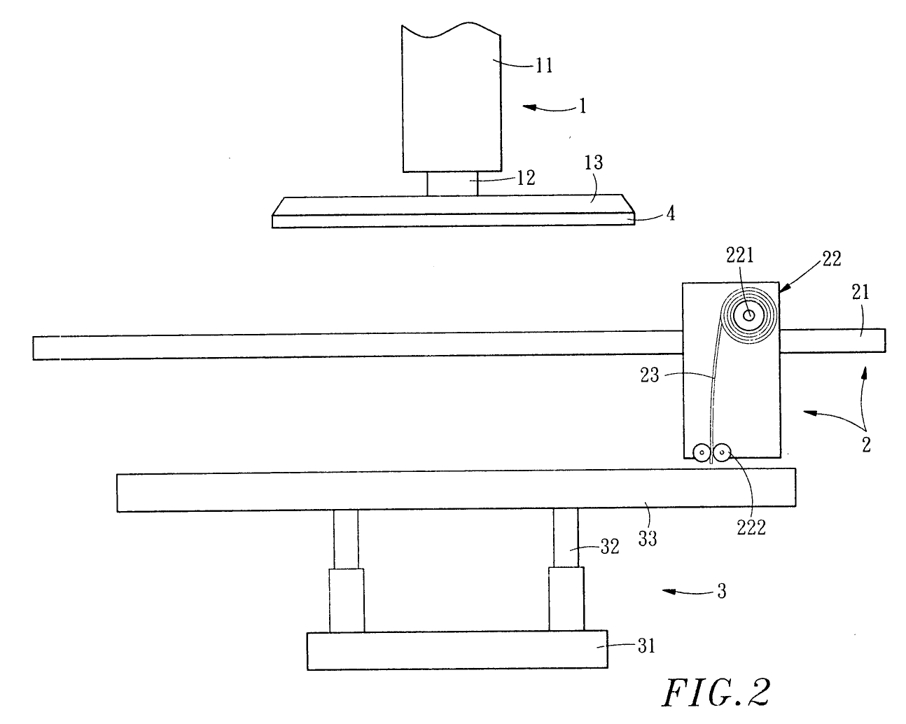

Referring to FIGS. 1 and 2, a reciprocating type protective cover sheet adhering machine in accordance with the present invention is shown comprised of a material feeder 1, a cover sheet applicator unit 2, and a machine base 3.

The material feeder 1 comprises a base 11, a reciprocating arm 12, and a suction board 13. The suction board 13 is suspended below the base 11. The reciprocating arm 12 is vertically coupled between the base 11 and the suction board 13, and controlled to move the suction board 13 vertically up and down relative to the base 11.

The cover sheet applicator unit 2 comprises a track 21 suspended above the machine base 3, an applicator body 22 coupled to the track 21, a let-off wheel 221 installed at the applicator body 22 near the top, a sheet-transfer wheel set 222 installed at the applicator body 22 near the bottom, and a roll of protective cover sheet 23 mounted on the let-off wheel 221 with the lead end of the protective cover sheet 23 inserted through the sheet-transfer wheel set 222.

The machine base 3 comprises a stand 31, a table 33, and lifting rods 32 coupled between the stand 31 and the table 33 and moved to adjust the elevation of the table 33 above the stand 31.

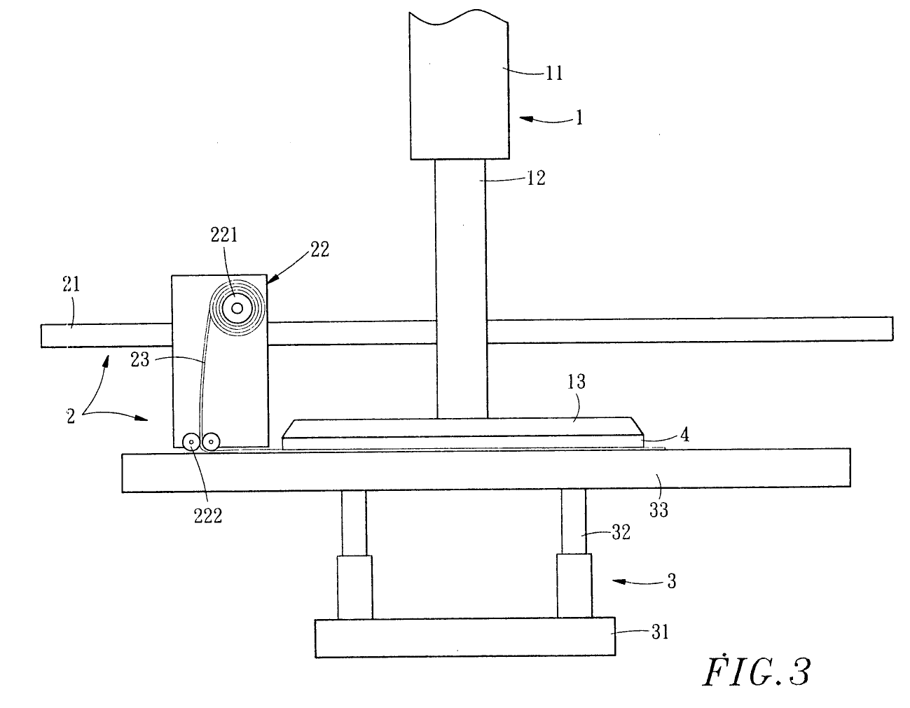

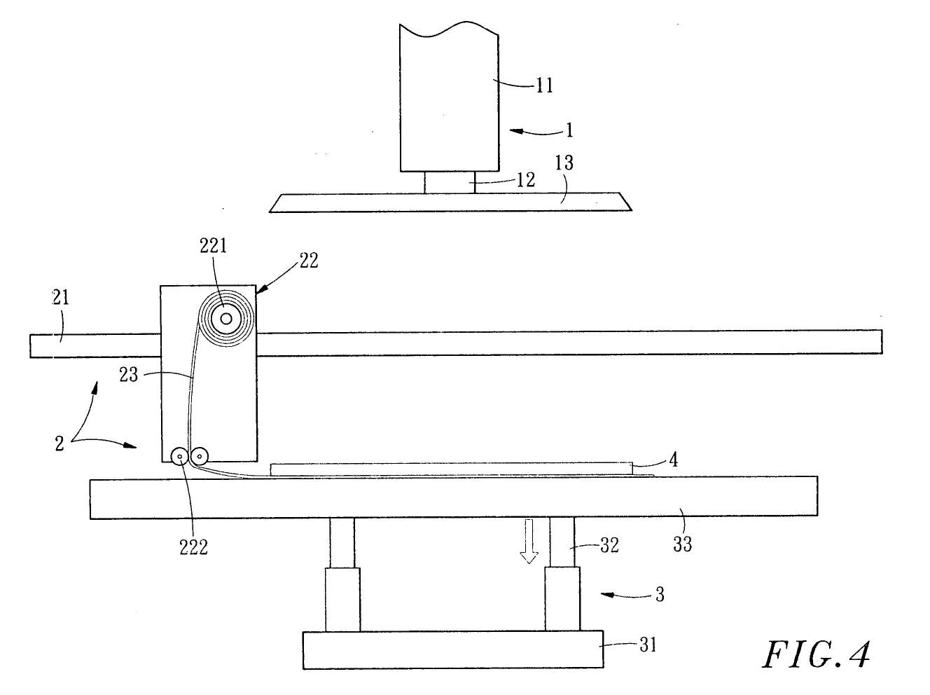

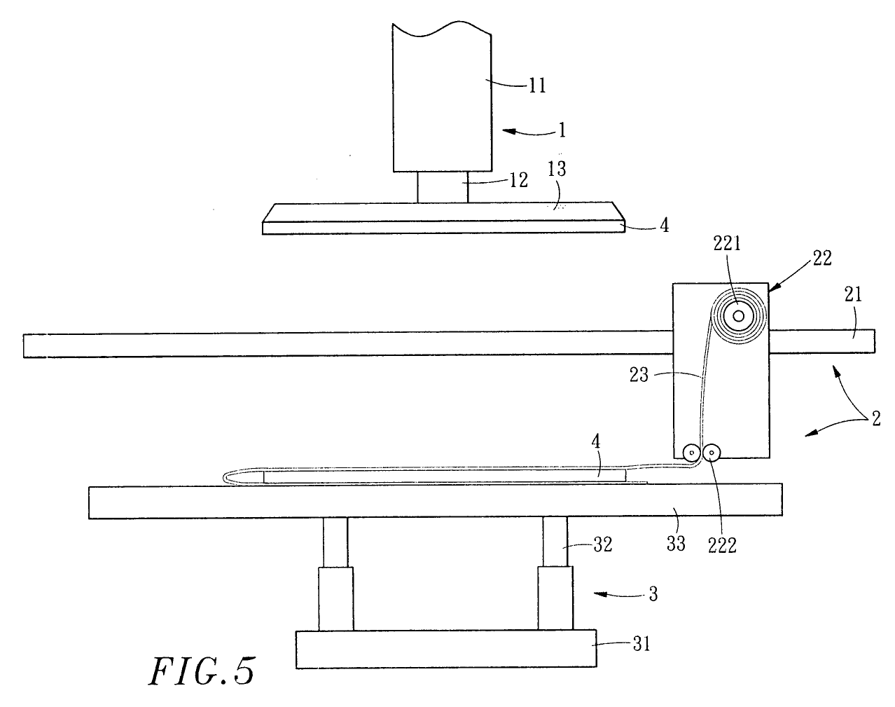

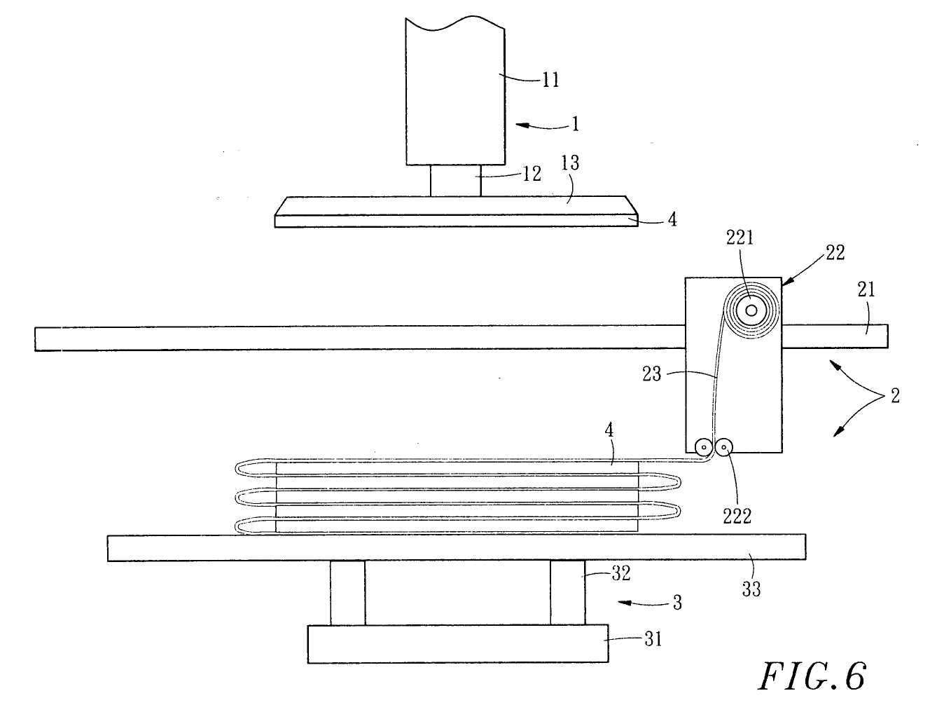

Referring to FIGS. 2˜6, when started, the applicator body 22 of the cover sheet applicator 2 is moved along the track 21 from one side of the table 33 to the other side, letting the protective cover sheet 23 to be laid on the top surface of the table 33, and then the suction board 13 of the material feeder 1 is operated to pick up a first plate member 4 (see FIG. 2) and then the reciprocating arm 12 is lowered to let the first plate member 4 be placed on the protective cover sheet 23 at the table 33 (see FIG. 3), and then the suction board 13 and the reciprocating arm 12 are lifted from the table 33 and the lifting rods 32 are lowered to such an elevation that the top side of the first plate member 4 and the bottom side of the sheet-transfer wheel set 222 are on the same horizontal plane (See FIG. 4), and then the applicator body 22 of the cover sheet applicator unit 2 is moved along the track 21 to its former position to let the protective cover sheet 23 be adhered to the other side (the top side) of the first plate member 4 (see FIG. 5), and therefore the top and bottom sides of the first plate member is adhered completely. After adhesion of the protective cover sheet 23 to the top and bottom sides of the first plate member 4, the reciprocating type protective cover sheet adhering machine is continuously operated to repeat the aforesaid procedure and to further adhere the protective cover sheet 23 to the top and bottom sides of a second plate member and then a third plate member, a fourth plate member . . . , until a predetermined number of plate members have been adhered with the protective cover sheet 23 (see FIG. 6.).

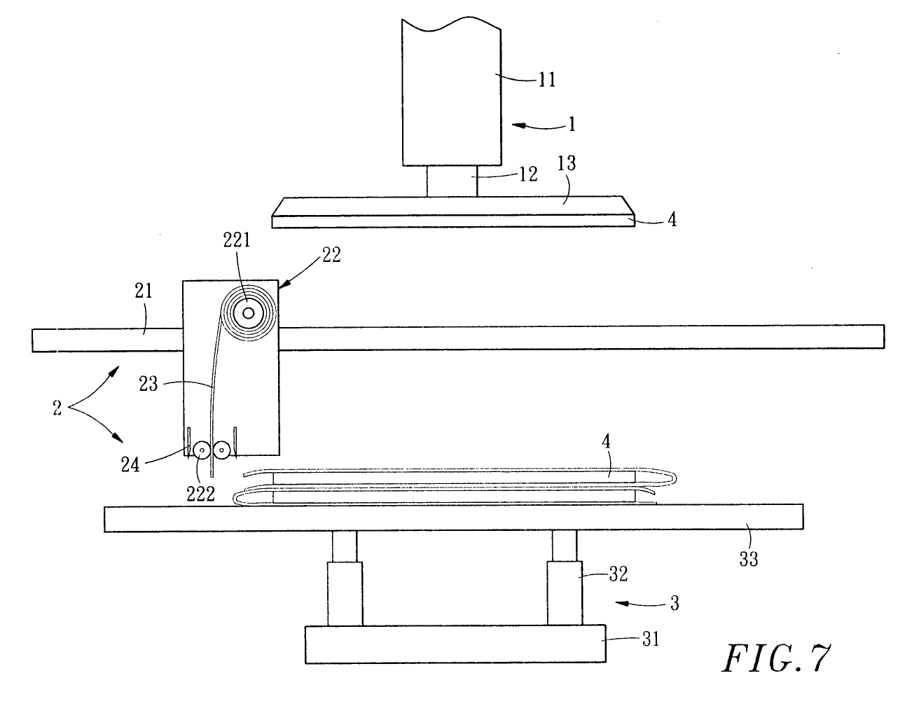

Referring to FIG. 7, the cover sheet applicator unit 2 further comprises a cutter unit 24 installed at the applicator body 22, and adapted to cut off the protective cover sheet 23 after adhesion of the protective cover sheet 23 to the top and bottom sides of each plate member 4. After cut, the cut piece of protective cover sheet has a part protruding over the two distal sides of the plate member 4 for protection.

As indicated above, the reciprocating type protective cover sheet adhering machine has the following advantages:

1. The invention enables the material feeder 1 to stack plate members 4 on the table 33 of the machine base 3, and applicator unit 2 to adhere a protective cover sheet 23 to the plate members 4 during stacking. Because the plate member stacking procedure and protective cover sheet adhesion procedure are automatically performed, the invention saves much labor and prevents scratching or stacking damage to the plate members during delivery and stacking.

2. The protective cover sheet 23 is alternatively adhered to the top and bottom sides of each plate member 4, leaving a part protruding over the two distal sides of each plate member 4 for protection, preventing damage to the packed plate members 4 during delivery.

A prototype of reciprocating type protective cover sheet adhering machine has been constructed with the features of FIGS. 1˜7. The reciprocating type protective cover sheet adhering machine functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

1. A reciprocating type protective cover sheet adhering machine comprising:
a machine base, said machine base comprising a table;
a material feeder adapted to place plate members on said table of said machine base in a stack; and
a cover sheet applicator unit, said cover sheet applicator unit comprising a track suspended above the table of said machine base below said material feeder, an applicator body adapted to be reciprocated along said track, a let-off wheel installed at said applicator body at a top side, a sheet-transfer wheel set installed at said applicator body at a bottom side, and a roll of protective cover sheet mounted on said let-off wheel for adhering to top and bottom sides of each plate member being carried by said material feeder to the table of said machine base, said protective cover sheet having a lead end inserted through said sheet-transfer wheel set for feeding.

2. The reciprocating type protective cover sheet adhering machine as claimed in claim 1, wherein said material feeder comprises a base, a suction board suspended below said base and adapted to pick up plate members for packing by suction, and a reciprocating arm vertically coupled between said base and said suction board.

3. The reciprocating type protective cover sheet adhering machine as claimed in claim 1, wherein said machine base further comprises a stand, and a plurality of lifting rods vertically coupled between said table and said stand and controlled to adjust the elevation of said table above said stand.

4. The reciprocating type protective cover sheet adhering machine as claimed in claim 1, wherein said applicator body is to be reciprocated along said track over the table of said machine base to adhere said protective cover sheet to top and bottom sides of each plate member being placed on the table of said machine base by said material feeder at a reciprocating distance greater than the length of the plate members to be packed such that a part of said protective cover sheet protrudes over two distal sides of each protective plate member after packing.

5. The reciprocating type protective cover sheet adhering machine as claimed in claim 1, wherein said cover sheet applicator unit further comprises cutter means disposed at said applicator body and adapted to cut off said protective cover sheet.
